(19) United States
(12) Patent Application Publication
(10) Pub. No.: US 2005/0183216 A1
(43) Pub. Date: Aug. 25, 2005

(54) Polamide composition comprising optical brightener yarns made therefrom, and process for heat setting such yarns

(75) Inventors: Michael G. Harriss, Gloucestershire (GB); Charles R. Langrick, Cleveland (GB); Robert Dewhurst, Gloucester (GB); Richard J. Merigold, Gloucester (GB)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA North America S.a r.I., Wilmington, DE (US)

(21) Appl. No.: 11/017,372

(22) Filed: Dec. 20, 2004

Related U.S. Application Data
(60) Provisional application No. 60/531,952, filed on Dec. 23, 2003.

(51) Int. Cl. C09B 67/00

(52) U.S. Cl. 8/555

(57) ABSTRACT

A polyamide composition, which includes an optical brightener together with either an antimicrobial agent or anti-oxidant stabilizer, or both, is suitable for making yarns, and fabrics, garments, molded articles or other articles such as carpets from these yarns. Processes for incorporating optical brighteners into polyamide compositions, polymers and yarns to make fabrics and molded articles that exhibit superior whiteness after heat-setting are also disclosed.

### BACKGROUND OF THE INVENTION

1. Field of the Invention

This invention relates to improved synthetic polyamide compositions and yarns made therefrom. More particularly the invention relates to a polyamide composition which includes an optical brightening agent and either an antimicrobial or anti-oxidant stabilizer, and yarns made from such compositions. The invention further relates to processes for manufacturing optically brightened polyamide compositions and yarns, and to dyed fabrics made from such yarns. The invention also relates to a process for making a heat-set polyamide fabric of superior whiteness, and also a process for the manufacture of molded articles of superior whiteness.

2. Description of the Related Art

All polyamides show some discoloration upon heat treatment. This problem is especially apparent in fabrics subjected to heat setting (spandex-containing fabrics, some lingerie and in the moulding of brassiere cups) in order to confer dimensional stability. The problem of nylon discoloration is particularly apparent with the use of antimicrobials. Many organic antimicrobials cannot easily be used in nylon since they react chemically during the melt-spinning process to form uncharacterized species. Most inorganic alternatives are based on compounds containing silver, and these have a particular propensity to cause discoloration, especially on heat setting or on subsequent laundering.

Polyhexamethylene adipamide, or nylon 6,6 (N66) polymer-based yarns in particular, often appear slightly yellow in color when compared side by side with polycaproamide, or nylon 6 (N6), polymer-based yarns. However, both yarns discolor when the fabrics are further heat set.

Manufacturers of both N66 and N6 yarns have sought remedies for yellowing of their products and generally have relied upon topical treatments with optical brighteners. The word “topical” in this context means a treatment applied locally to the surfaces of the fabric. Topical treatment of yarns, fabrics or garments with optical brighteners is effective, but not permanent. The method of topically treating fabrics with optical brighteners is known as “padding-on.” Alternatively, yarns or fabrics may be dyed in a conventional way, using an optically brightening white dye. However, in either case, the optical brightening effect is gradually lost in subsequent textile treatments like dyeing and common laundry operations.

A report published by EASTMAN Chemical Company Publication AP-27C, December 1996 discloses the use of an optical brightener, EASTOBRITE® OB-1 [2,2′-(1,2-ethenediyldi-4,1 phenylene)bisbenzoxazole] with nylon 6 “fiber-grade” resins. These optical brighteners function by absorbing the ultraviolet portion of the spectrum and re-emitting light in the blue region of the visible spectrum. The blue fluorescence reduces the appearance of yellow color in the material containing the optical brightener. The EASTMAN report discusses blending powdered optical brighteners (a triazine type, coumarin type, benzooxazole type, stilbene type and OB-1) with two polyamide nylon 6 resins. These resins were a first delustered resin containing 0.3% titanium dioxide and a second with 1.6% titanium dioxide. These nylon 6 resins were ground to 3 millimeter mesh size and dry blended with the brightener compositions. The differently optically brightened nylon 6 resins were spun into drawn yarns and knitted to make fabrics which were scoured prior to lightfastness and whiteness measurements. The EASTMAN report also discusses blending a brightener with molten nylon 6,6 in a wet, oxygen free atmosphere to “simulate production conditions.” EASTMAN reported that EASTOBRITE® OB-1 was “stable and retained its fluorescence” in this blend. However, no fiber spinning results or whiteness data were reported for nylon 66. Also not reported by EASTMAN, for any polyamide, were the important fiber properties of tensile strength and light fastness.

Prior art remedies to retain whiteness of synthetic polymer based yarns and fabrics, especially remedies sought for improving nylon 6,6 “fabric whiteness,” are not adequate for commercial manufacturing processes. As noted above, the conventional padding or dyeing techniques are expensive and do not retain their activity over time. As such, a need still exists for incorporating optical brighteners into synthetic polyamide polymers to achieve a permanent whiteness improvement unaffected by fabric post-processing, such as heat setting. Furthermore, the methods of padding-on and white-dyeing are limited to white fabrics; it is highly desirable to find a method which will produce a good white fabric which can then be dyed subsequently to give cleaner brighter colors.

### SUMMARY OF THE INVENTION

Applicants have observed that yarns made from synthetic polyamide compositions can be improved in whiteness appearance by incorporating an optical brightener into the yarn itself. Such yarns exhibit a permanent whiteness improvement and can retain this whiteness improvement through operations such as heat setting. In certain cases, they also result in a cleaner, more intensely colored fabric when the fabric is dyed. This effect on colored fabrics cannot be achieved through conventional optical brightening techniques, as the brightener is removed from the fabric during the dyeing process.

In addition, these polyamide compositions may contain an anti-oxidant stabilizer, or an antimicrobial additive. The use of an optical brightener with an antimicrobial agent is particularly beneficial since nylon yarns with silver-based antimicrobials otherwise tend to discolor, especially on heat setting or on subsequent laundering.

The nylon polymers and copolyamides of the present invention are inherently dyeable by acid, reactive and disperse dyes in particular, but may also be rendered into a basic dyeing form by modifying these polymers or copolymers with an additive such as 5-sulfo-isophthalic acid copolymerized in the polymer. This modification makes yarns made from such composition particularly receptive to coloration with base dyes. The polyamide composition may also include other additives well-known in the art (UV absorbers, light stabilizers, catalysts, nucleating agents, colored pigments, for example, and not limited to these).

Therefore, in accordance with the present invention, there is provided a polyamide composition comprising an optical brightener together with an antimicrobial agent or an anti-oxidant stabilizer, or both. The polyamide composition typically may be polyhexamethylene adipamide or polycaproamide, or copolymers thereof but is not limited to these polymers and copolymers. The polyamide composition may be either an acid dyeable polymer, or a base dyeable (cationic dyeable) polymer. The present invention is also directed to yarns made from such compositions, and fabrics and garments made from such yarns, to dyed fabrics containing an optical brightener, and to processes for manufacturing the polymers, compositions and yarns.

Further in accordance with the present invention, there is also provided a process for producing a heat-set nylon fabric of satisfactory whiteness, comprising: constructing a fabric from an optically brightened nylon yarn, heating the fabric to a temperature in the range of about 160° to about 220° Celsius for a period of about 20 seconds to about 90 seconds, wherein the fabric has a CIE whiteness of at least 75, measured after heat-setting.

There is further provided in accordance with the present invention, a process for manufacture of a molded article such as a brassiere cup of improved whiteness. A fabric made with an optically brightened nylon yarn is subjected to heat and pressure in a mold for a pre-determined time.

Other objects of the invention will be clear from the following description.

### DESCRIPTION OF THE PREFERRED EMBODIMENTS

In accordance with the present invention, there is provided a polyamide composition which includes an optical brightener. The polyamide composition may comprise an acid-dyeable polymer or a base-dyeable polymer (also known as cationic modified polymer). The polyamide composition may be typically either of polyhexamethylene adipamide (nylon 6,6), or polycaproamide (nylon 6), or copolymers of either of these polyamides. The optical brightener is present in an amount of about 0.005 to about 0.2 percent by weight of the composition.

The polyamide composition of the present invention further comprises an antimicrobial agent or an anti-oxidant stabilizer, or a combination of the two additives. The antimicrobial agent may be a silver-containing compound. The antimicrobial is typically present in the composition in an amount of about 0.1 to about 1.0 percent by weight. The concentration of anti-oxidant may be in the range of 0.1 to 2% by weight where an organic system is used, but may be as low as 5 ppm where the anti-oxidant is based on the use of copper ion containing compounds. The additives of the present invention may be comprised of more than one optical brightener, antimicrobial or anti-oxidant additive.

The polyamide composition of the present invention may be made by adding the optical brightening additive (OBA) before, during or after polymerization. That it is to say, the OBA may be introduced with the monomeric materials themselves (hexamethylene diamine and adipic acid in the case of nylon 6,6; or caprolactam in the case of nylon 6), or while those monomeric materials are being processed into polymer, or introduced into the molten polymer once the polymerization process is completed. Alternatively, the OBA may also be compounded at a higher concentration into a masterbatch by use of a carrier polymer, after which polymer granules of this masterbatch are metered into conventional polymer prior to melting, mixing and extruding into filaments. Alternatively, masterbatch concentrate or the pure OBA may be melted and fed as a separate stream into the normal molten polymer flow, as opposed to mixing the solid granules, for subsequent mixing and extrusion.

Specifically, the polyamide composition may be made by an autoclave process. In this process a concentrated aqueous solution of nylon 6,6 salt may be provided to an autoclave vessel. The solution may be prepared from an aqueous solution of the monomers hexamethylene diamine and adipic acid, in the manner known in the art. Optionally, the solution may also contain minor amounts of other monomers such as diamines, dicarboxylic acids, or nylon 6 monomer as a caprolactam solution. The optionally added co-monomers may be mixed with the nylon 6,6 salt in an amount to provide a final copolymer content of about 0.5 to about 20 percent by weight. The autoclave vessel may then be heated to about 220° C. allowing the internal pressure to rise. Other additives such as the delusterant, titanium dioxide (TiO₂), may optionally be injected as an aqueous dispersion into the autoclave at this point.

In order to provide an optically brightened polymer, an aqueous dispersion of an optical brightener may also be injected into the mixture in the autoclave vessel at this same point. Alternatively, the optical brightener may be added as an aqueous dispersion or solution in an organic solvent such as caprolactam, when the concentrated salt solution is first introduced into the autoclave. Alternatively, the optical brightener may have been included when the salt solution was first prepared, prior to concentration and introduction into the autoclave. The mixture may then be heated in the autoclave to about 245° C. While at this temperature, the autoclave pressure may be reduced to atmospheric pressure and may also be further reduced in pressure by application of a vacuum in the known manner, to form the polyamide composition. The autoclave, containing the polyamide composition, would typically be maintained at this temperature for about 30 minutes. This step may be followed by further heating of the polyamide polymer composition in the autoclave to about 285° C. and introducing dry nitrogen to the autoclave vessel and pressurizing the autoclave to about 4 to about 5 bar absolute pressure. The polymer composition may be released from the autoclave by opening a port in the autoclave vessel and allowing the molten polyamide composition to flow from the vessel in the form of laces. These laces may be cooled and quenched in a current of water. Next, the laces of polyamide polymer may be granulated by known means and further cooled with water.

Alternatively, the composition may be prepared by a continuous polymerization (CP) route. For nylon 66 and its copolymers, the essential process steps are similar to the autoclave process. A concentrated solution of Nylon 66 salt and appropriate comonomers is introduced to a pre-polymerizer unit, where most of the water is removed, and the mass polymerizes to a polymer of low molecular weight. The melt then passes down heated tubes and emerges as a higher molecular weight polymer from which the steam can be removed in a separator unit. The molten polymer may then be extruded as laces, cooled in water and cut into granules suitable for drying, optionally increasing the degree of polymerization in the solid phase, and remelting for subsequent spinning. Alternatively, the CP line may be connected to a spinning machine, so that direct spinning is possible, without passing through the intermediate steps of cooling and cutting to granules. As in the batch process, the optical brightener may be introduced at several different points, preferably as an aqueous dispersion. Thus the optical brightener may be added to the original salt solution before concentration, or introduced into the first stage of polymerization at the same time as the concentrated salt solution, or injected further downstream into the melt, or even injected in the molten state into the final emerging polymer stream.

Nylon 6 and its copolymers are almost always produced by a CP route, in which caprolactam, small amounts of water, and an initiation catalyst such as acetic or benzoic acid are fed together with comonomers and additive slurries such as titanium dioxide, into the CP polymerizer. This is frequently a simple VK tube, but modern plants generally use a two stage system including a pre-polymerizer vessel. The mixture is subjected to heat, steam is removed, and the polymer mass is pumped to an extrusion die, where the extruded laces are cooled under water, and cut to granules. The granules are normally extracted with hot water to remove monomer, then dried for subsequent spinning. A direct coupling to spinning plant is rare, because of the difficulty in extracting monomer and oligomers. To produce an optically brightened polymer, the optical brightener can be included at any stage of the process, but by far the most convenient is to supply the agent as an aqueous slurry at the entrance to the system, together with the other raw materials. General methods for the manufacture of nylon polymers are well-summarized for the skilled practitioner in the “Nylon Plastics Handbook”, Edited by M. I. Kohan, ISBN 3-446-17048-0.

Alternatively, the polyamide composition of the present invention may be made by a masterbatch process, in which a high concentration of optical brightening agent, for example 1-10% by weight, is incorporated into a suitable carrier polymer, preferably a polyamide. Such a masterbatch may in theory be manufactured by any of the methods outlined above provided that the appropriate high concentration of additive can be attained. However it is more typical to use a compounding process, in which predetermined amounts of powdered additive and carrier polymer are mixed, melted together in an extruder, extruded into laces, cooled by water and cut into granules. Subsequent blending of the granules gives a concentrate that is uniform throughout. This concentrated masterbatch may then be either mixed with normal polymer granules via a metering system, and the two melted together to give the composition of the invention, or the masterbatch may be melted separately, and then injected into the flow of molten standard polymer. Where more than one ingredient is to be added, for example an optical brightening agent together with an antimicrobial agent and/or an anti-oxidant, it is highly advantageous to compound all the ingredients together into a single polymer masterbatch.

Various alternatives may be made to the present invention without departing from the scope thereof. For instance, the optical brightener may be melted without recourse to a masterbatch, and then injected into the flow of molten standard polymer at the entrance to a spinning machine. Alternatively, the optical brightener may be dosed in solid powdered form to a standard polymer at any stage, as implied in the Eastman reference, but this dosing may make it difficult to control the concentration. Alternatively, an optical brightener may be incorporated into an emulsifiable wax, which is then used to form an aqueous dispersion. The dispersion is sprayed on to polyamide polymer granules in the required amount, and then dried. The treated granules can then be melted and spun into fiber.

Either the masterbatch processes, the CP processes or the autoclave process described above can provide a polyamide composition with a formic acid method relative viscosity (RV) of about 32 to about 62 and about 45 gram equivalents of amine ends per 1000 kilograms of polymer. Optionally, either process may be modified to make a polyamide composition having about 50 to about 75 gram equivalents of amine ends per 1000 kilograms of polymer, provided by the addition of an excess of organic diamine such as hexamethylene diamine solution to the aqueous solution of nylon 6,6 salt, or with the caprolactam feed to a nylon 6 polymerizer. In addition, the polymers may be further polymerized in a solid phase unit, to much higher viscosity levels

The nylon polymers and copolyamides described herein are inherently acid-dyeable. The number of free amine end groups (AEG) in these polymers is at least 25 gram equivalents per 1000 kilograms of nylon polymer. In order to make the polymers more deeply acid dyeing an enhanced level of free amine end groups is desired. More deeply acid dyeing nylon polymers have an enhanced AEG level, at least 35 gram equivalents per 1000 kilograms of nylon polymer; and AEG levels of 60 to 130 gram equivalents per 1000 kilograms of nylon polymer may be used.

The nylon polymers and copolyamides described herein may also be rendered into a basic dyeing form, i.e., receptive to coloration with base dyes also called cationic dyes. Such base-dyeing yarns are made from polyamide polymer with a cationic dye modifier copolymerized in the polymer. U.S. Pat. No. 5,164,261 to Windley, herein incorporated by reference in its entirety, describes the preparation of such cationic dye modified polyamides. In the present invention, it is preferred to modify the polymer during polymerization with from 0.3 to 4 percent of the preferred cationic dye modifier the sodium salt of 5-sulfoisophthalic acid, or its dimethyl ester. Typically, a weighed quantity of the sodium salt of 5-sulfoisophthalic acid, or of its dimethyl ester, is combined with a known amount of the polyamide precursor salt in an autoclave using standard polymerization procedures known in the art. Preferably, the polymer contains cationic dye modifier in the amount of from about 0.75 to about 3 weight percent, as determined by total sulfur analysis of the polymer. This amount of cationic dye modifier is reported as equivalent sulfonate groups. The preferred sulfonate groups concentration is at least 25 gram equivalents per 1000 kilograms polymer up to about 200 gram equivalents per 1000 kilograms polymer.

The polyamide composition of the present invention is particularly useful when spun into yarns, because the optical whitener is in the composition, and hence in the yarn itself when fabric is formed, as opposed to being padded on to a fabric. The yarns of the present invention exhibit improved whiteness, especially after fabric processing such as heat setting. A further advantage is that the optically whitened fabrics may subsequently be dyed in a conventional way, using acid dyes, cationic dyes, reactive dyes etc., to give colored fabrics that appear cleaner, fresher and brighter than standard fabrics. This result is impossible to achieve through padding-on or white-dye methods, because the brightening agent comes off during the dyeing process.

Typically, the yarn of the present invention is a multifilament textile yarn in the form of either a low orientation yarn (LOY), a partially oriented yarn (POY) or a fully drawn yarn (FDY). The yarn may be a textured yarn made from partially oriented yarn, or an air-jet textured yarn. Moreover, the yarn of the present invention may be substantially continuous or comprised of shorter lengths. Such yarns may be used to make fabrics, which in turn may be used to make garments. Also, the yarns of the present invention may be bulked continuous filament yarns (BCF) or spun staple, and have utility as carpet yarns. The yarns may also be higher strength industrial yarns, where there are clear advantages in certain areas, such as clear bright-colored fabrics for hot-air balloons, or in a more durably white yarn in shoe-laces for sportswear.

Yarns of the invention may be prepared by adapting known melt-spinning process technology. With such technology, the granulated polyamide composition made by using a CP or autoclave process, both having an optical brightener therein as described above, is provided to a spinning machine. The granulated polyamide composition may also contain a blend of standard polymer with a measured amount of masterbatch concentrate comprising a carrier resin with the optical brightener and optionally other additives. Alternatively the optically brightened molten output from a continuous polymerizing unit (CP) may be coupled directly to such a spinning machine. The molten polymer is forwarded by a metering pump to a filter pack, and extruded through a spinneret plate containing capillary orifices of a shape chosen to yield the desired filament cross-section at the spinning temperature. These cross-sectional shapes include circular, non-circular, trilobal and diabolo, hollow or many others. Spinning temperatures are typically in the range of 270° to 300° C. for nylon 66 and its copolymers, and 250° C. to 280° C. for nylon 6 and copolymers. The bundle of filaments emerging from the spinneret plate is cooled by conditioned quench air, treated with spin finish (an oil/water emulsion), and optionally interlaced. In the case of FDY (Fully Drawn Yarn), the in-line processing on the spinning machine consists of making several turns around a set of godet rolls (feed rolls), the number of turns being sufficient to prevent slippage over these rolls, and then passing the yarn over another set of rolls (draw rolls) rotating at sufficient speed to stretch the yarn by a predetermined amount (the draw ratio), and finally heating and relaxing the yarn; for example, with a steam-box, before winding up on a take-up device. Speeds of at least 4000 meters per minute are typical of modern processes. Optionally, an alternative heating (or relaxing) method may be used, such as heated rolls, and an additional set of godet rolls may be incorporated between the draw rolls and the winder to control the tension while the yarn is set or relaxed. Also, optionally, a second application of spin finish, and/or additional interlacing may be applied before the final winding step. In the case of POY, the additional in-line processing consists only of making a S-wrap over two godet rolls rotating at essentially the same speed, and then passing the yarn to a high speed winder, and winding at a speed of at least 3500 meters/min. Use of the S-wrap is beneficial to control tension, but not essential. Such a POY may be used directly as a flat yarn for weaving or knitting, or as a feedstock for texturing. The LOY spinning process is similar to POY except that a lower windup speed, of perhaps 1000 m/min or below is used. These low orientation yarns, in general, are further processed via a second stage, e.g., on a conventional draw-twister or draw-wind machine.

Further in accordance with the present invention, there is also provided a process for heat setting an optically brightened nylon yarn, comprising: heating the yarns to a temperature for a period of about 20 seconds to about 90 seconds, wherein the yarn has a CIE whiteness of at least 75, measured after the yarn was heatset at a temperature in the range of about 160° to about 220° Celsius. Preferred is a heat setting temperature of 185° C. and a heating period of 45 seconds. In this method an anti-oxidant additive may be included in the yarn used. The anti-oxidant may be an organic substance such as a hindered phenol, or a mixture of substances. In a preferred embodiment, copper ion, preferably >5 ppm, and a halide are used as the anti-oxidant with the optical brightening agent. There is also provided a process for producing an optically brightened nylon article, such as a molded brassiere cup, under these conditions.

### Test Methods

Yarn tenacity and the yarn elongation are determined according to ASTM method D 2256-80 using an INSTRON tensile test apparatus (Instron Corp., Canton, Mass., USA 02021) and a constant cross head speed. Tenacity is measured according to the method of ISO-2062, and is expressed as centi-Newtons per tex (cN/tex). The yarn percent elongation is the increase in length of the specimen, measured at breaking load, expressed as a percentage of the original length.

Polymer RV is measured using the formic acid method according to ASTM D789-86, but using an Ubbelohde viscometer instead of the Ostwald type.

Polymer amine end concentration is measured by directed titration with standardized perchloric acid solution of weighed polymer samples dissolved in phenol/methanol mixture. Solutions were not filtered to remove insoluble delustering pigments, but allowance was made for them in calculating the concentrations.

Yarn whiteness was determined using a test method conforming to the CIE whiteness rating for each yarn sample. Samples were measured individually for whiteness (W) and yellowness (Y), using a GRETAG MACBETH “COLOR EYE” reflectance spectrophotometer. First, by determining the color coordinates L, a and b; and then, calculating W and Y by means known in the art (see: ASTM Method E313-1996 Standard Practice for Calculating Whiteness and Yellowness Indices from Instrumentally Measured Color Coordinates). Details of this measurement are found in Color Technology in the Textile Industry 2nd Edition, published by Committee RA 36, AATCC (1997); see in this volume: Special Scales for White Colors by Harold and Hunter, pp 140-146, and the references therein; all are incorporated herein by reference in their entirety.

### EXAMPLES

### Examples of the Invention with Optically Brightened Polymer

In examples of the invention, yarns of 96 dtex and 68 circular cross section filaments were prepared from a nylon 66 polymer of 40 RV, 50 AEG (amine end groups per 1000 kilograms of polymer) which contained 0.009% by weight TiO₂, together with a masterbatch of optical brightener in a nylon 6 based carrier resin, from Americhem UK Ltd. The yarns contain varying amounts of optical brightener, and therefore varying amounts of nylon 6 polymer in which the optical brightener was dispersed; as shown in Table 1. The polymer was melt spun and processed as a POY, as described above. These yarns were textured and knit into yarn tubes, heat set at several temperatures in the range of 185° C. to 200° C., and then measured for CIE whiteness using the test method conforming to the CIE whiteness rating as described above.

TABLE 1

| | | | CIE whiteness |
|---|---|---|---|
| | % optical | | @ heat set |
| Example | brightener | % nylon 6 | temperature |
| 1. | 0.02 | 0.98 | 95 (185° C.) |
| | | | 65 (200° C.) |
| 2. | 0.04 | 1.96 | 95 (185° C.) |
| | | | 70 (200° C.) |
| 3. | 0.08 | 3.92 | 90 (185° C.) |
| | | | 60 (200° C.) |
| 4. | 0.16 | 7.84 | 75 (185° C.) |
| | | | 55 (200° C.) |

### Comparative Examples

In a series of comparative examples, yarns of 96 dtex and 68 circular cross section filaments was prepared from a nylon 66 polymer of 40 RV, 50 AEG (amine end groups per 1000 kilograms of polymer) which contained 0.009% by weight TiO₂ varying amounts of nylon 6 polymer, but no optical brightener; as shown in Table 2. This was to verify that any effects seen in the first examples 1-4 of Table 1 above were indeed due to the presence of the optical brightener, and not to the small amounts of adventitious nylon 6 which accompanied them in the masterbatch.

TABLE 2

| | | | CIE whiteness |
|---|---|---|---|
| Comparative | % optical | | @ heat set |
| Example | brightener | % nylon 6 | temperature |
| 1. | 0.0 | 0.00 | 65 (185° C.) |
| | | | 40 (200° C.) |
| 2. | 0.0 | 0.98 | 65 (185° C.) |
| | | | 45 (200° C.) |
| 3. | 0.0 | 1.96 | 70 (185° C.) |
| | | | 40 (200° C.) |
| 4. | 0.0 | 3.92 | 65 (185° C.) |
| | | | 42 (200° C.) |
| 5. | 0.0 | 7.84 | 68 (185° C.) |
| | | | 48 (200° C.) |

These data in Tables 1. and 2. show that nylon 6,6 molten polymers optically brightened with 0.02 to 0.04 percent by weight additive is highly beneficial to post heat setting retention of yarn whiteness. Specifically, the yarns of the invention are superior in whiteness retention after heat setting at 200° C. to the comparative examples heat set at a lower temperature (185° C.).

### Example of Optically Brightened Polymer with Anti-Oxidant Additive

A first yarn exactly like Example 2 in Table 1, and a second yarn exactly like Example 1 in Table 2 were prepared, with the exception that both yarn polymers contained 0.2% IRGANOX® B1171, a polymer anti-oxidant obtained from CIBA Specialty Chemicals Company, High Point, N.C., USA. Chemically, this anti-oxidant is a mixture of the hindered phenol IRGANOX® 1098, and the organic phosphite IRGAFOS® 168. The yarns were knitted in the same manner as before, heat set and measured for CIE whiteness. These data are shown in Table 3, and indicate a superior whiteness is obtained by the further addition IRGANOX® B1171 anti-oxidant to the polymer.

TABLE 3

| | | | | CIE whiteness/ | | |
|---|---|---|---|---|---|---|
| | % | | | heat-set temp | | |
| | optical | | % | No | | |
| | bright- | % | IRGANOX ® | heat- | 185° | 200° |
| | ener | nylon 6 | B1171 | set | C. | C. |
| Comparative | 0 | 0 | 0.2 | 85 | 83 | 72 |
| Example | | | | | | |
| Example 1 | 0.04 | 1.96 | 0 | 121 | 95 | 71 |
| Example 2 | 0.04 | 1.96 | 0.2 | 124 | 113 | 101 |

Example 1 of Table 3 shows that the use of an optical brightener gives a yarn that is much whiter than that achieved by spinning standard polymer (even when the latter contains an anti-oxidant), although this whiteness is progressively lost at higher setting temperatures. Example 2 shows that by using an optical brightener in conjunction with an anti-oxidant, it is possible to produce a yarn or fabric that is whiter, even after heat-setting at 200° C., than yarn from standard polymer without heat-setting.

### Example of Optically Brightened Polymer with Antimicrobial Additive

Yarns were prepared in a manner similar to those in Table 1. with the exception that the dull luster polymer contained 1.5% titanium dioxide, varying amounts of nylon 6 and optical brightener and 0.25% of the silver-based IONPURE antimicrobial additive (obtained from the Ishizuka Glass Company and made into a masterbatch with nylon 6 by Wells Plastics Limited of Stone, Staffordshire, UK) The yarns were knitted in the same manner as before, heat set and measured for CIE whiteness. These data are shown in Table 4.

TABLE 4

| | | | | CIE whiteness/ | | |
|---|---|---|---|---|---|---|
| | % | | % | Heat-set temp | | |
| | optical | | IONPURE | No | | |
| | bright- | % | anti- | heat- | 185° | 200° |
| | ener | nylon 6 | microbial | set | C. | C. |
| Comparative | 0.00 | 0.00 | 0.00 | 81 | 77 | 60 |
| Example. | | | | | | |
| Example 1 | 0.00 | 1.00 | 0.25 | 70 | 65 | 55 |
| Example 2. | 0.025 | 2.225 | 0.25 | 105 | 95 | 82 |

In Table 4, the data of the comparative example show the whiteness result to be expected on spinning a yarn from standard polymer, and how this deteriorates from 81 to 77 to 60 as the yarn is heat-set at progressively higher temperatures.

The data of Example 1 show how the incorporation of a small amount of silver-based antimicrobial agent causes a significant and unacceptable loss of whiteness in the yarn as spun, from 81 to 70 units, even without heat-setting, and how much worse this becomes as the temperature is raised.

The data of Example 3 show how the incorporation of an optical brightener alongside the antimicrobial agent gives a yarn that is superior in whiteness to the yarn of the comparative example without antimicrobial agent present, and remains of acceptable whiteness level even after setting at 200 degrees C.

The small amounts of nylon 6 also present in these samples arise because this is the carrier polymer used in the masterbatch, and do not have any significant effect on the whiteness data.

### Examples of Optically Brightened Base Dyeable Yarns

Two Yarns were prepared in a manner similar to those in Table 1, with the exception that the polymer was base (cationic) dyeable. A first yarn contained some nylon 6 and the optical brightener of Table 1.

A second comparative yarn of the same base dyeable polymer had no optical brightener. These yarns were treated as those in Table 1 and measured for CIE whiteness, reported in Table 5.

TABLE 5

| | | | CIE whiteness |
|---|---|---|---|
| | % optical | % | @ heat set |
| | brightener | nylon 6 | temperature |
| Comparative Example | 0.00 | 0.00 | 65 (185° C.) |
| Base Dyeable Polymer | | | 40 (200° C.) |
| Example | 0.04 | 1.96 | 95 (185° C.) |
| Base Dyeable Polymer + | | | 73 (200° C.) |
| optical brightener | | | |

### Examples of a Production Process for Manufacturing Optically Brightened Polyamide 66 Polymer

Nylon-6,6 homopolymer was prepared from a 51.5% aqueous solution of nylon-6,6 salt (prepared from hexamethylene diamine and adipic acid) placed in an agitated vessel together with a desired amount of a 30% aqueous hexamethylenediamine solution (the amount of excess diamine added to give the desired amine end group level in final polymer is determined by experimentation since some diamine is lost by evaporation) together with 44 parts per million of an antifoaming agent and about 100 ppm Eastobrite OB-1. The mixture was evaporated by heating from room temperature to 155° C. under 2.7 bar absolute pressure. Evaporation was terminated at 80 to 85% solids content. The concentrated slurry was transferred under an inert gas (nitrogen) to an autoclave and heat applied to the vessel to raise the temperature of the mixture. The autogenous pressure in the autoclave was maintained at 18.2 bar absolute. At 230° C. and 18.2 bar absolute, 330 parts per million of a 40% aqueous dispersion of TiO2 were injected into the autoclave using a 20 bar nitrogen pressure. At 245° C. the pressure in the autoclave was reduced to atmospheric pressure and further reduced to 0.65 bar absolute by the application of vacuum to the vessel and maintained for a period of about 30 minutes. The temperature of the vessel was maintained above the melt temperature of the polymer now formed, and the vessel pressure was then increased to atmospheric by removal of vacuum and introduction of dry nitrogen. Pressurized nitrogen at 4 to 5 bar absolute at about 285° C. was introduced to the vessel. The overpressure allowed the polymer melt to flow, in the form of laces, from a vessel opening into a current of cooling water. These quenched laces of polymer were chipped (granulated) and further cooled with water. The polymer chips (about 4 mm long by 3 mm diameter) were then separated from the water and dried in air to a temperature below about 60° C. The resulting nylon 6,6 homopolymer had a relative viscosity (RV) of 38 to 50 as measured in 90% formic acid, indicative of a balance between amine and carboxyl end groups. The measured amine end groups are typically about 45 to 55 gram equivalents per 1000 kg of polymer (as measured by titration and comparison to known polymer standard samples). The polymer so prepared contained 0.025 to 0.035% titanium dioxide TiO₂ delustrant, and about 0.02% of the optical brightening agent Eastobrite OB-1. The experiment was repeated using a different optical brightener, Uvitex OB, at different concentrations. Properties of the polymer are recorded in Table 6, below.

TABLE 6

| | Optical | Concentration | | |
|---|---|---|---|---|
| | Brightener | w/w % | RV | Amine Ends |
| Example 1 | Eastobrite OB-1 | .02 | 47.2 | 54.0 |
| Example 2 | Uvitex OB | .01 | 48.0 | 54.8 |
| Example 3 | Uvitex OB | .05 | 47.7 | 55.0 |

### Examples of Fabric That Are Both Optically Brightened and Subsequently Over-Dyed to Give Colored Fabrics

There is no prior experience of the effects of dyeing an optically brightened polyamide fabric, because the very act of dyeing removes from the fabric most or all of the optical brightener that has been padded on, or applied as a white dye.

### Example 1

A POY yarn of 96 decitex and 68 filaments was prepared in the known manner from bright (0.009% TiO2 level) nylon 66 polymer, of a nominal 40 RV value, then false-twist textured into a textured yarn of 76 decitex. The yarn was knitted into a panel, and the fabric heat set at 190° C. for 45 seconds. After this, the fabric was dyed at 98° C. for 60 minutes at atmospheric pressure, using a 1.5° C./minute rate of temperature rise. The dyestuff used was 0.15% Nylosan Brilliant Blue N-FL (180% strength) at pH 7. A second POY yarn was made, textured, converted to a fabric and dyed, exactly as above, except that 0.04% of optical brightening agent was incorporated via masterbatch addition (Americhem) into the standard bright polymer. The amount of nylon 6 carrier polymer in the final yarn amounted to 1.96%

Although both fabrics had dyed to essentially the same depth of shade, the fabric containing the optical brightener was visibly cleaner and less yellow than the fabric from the standard polymer Instrumentally measured color values are reported in Table 7 below.

TABLE 7
CIE L*a*b* Values

| Fabric | L | a | b | C | h |
|---|---|---|---|---|---|
| Standard | 65.28 | −3.03 | −35.45 | 35.58 | 265.11 |
| With OBA | 65.89 | −2.16 | −39.02 | 39.08 | 266.82 |

The ‘b’ value (yellow-blue axis) confirms the assessment that the fabric made with the optically brightener is less yellow, by almost 4 units, while the ‘C’ (Chroma) value shows that it is also brighter than the control.

### Example 2

This example with two different turquoise dyes revealed that not only is it possible to make a brighter, cleaner colored fabric by using an optically brightened yarn, but that surprisingly, an optically whitened fabric made with the duller of the two dyes can achieve a brilliance normally only achievable with the brighter dye. This is important, since the more brilliant dyes are generally of higher molecular weight, and are notoriously difficult in the trade where a uniform, stripe-free appearance is required. The use of a smaller dye molecule with a an optical brightener offers a much easier way to uniform fabrics in selected colors.

The textured yarns of Example 1 above, i.e. 96f68 POY, with and without optical brightener, and draw-textured to 76 decitex, were again knitted into fabrics and heat set, this time at 185° C. for 45 seconds. Fabrics were then scoured and dyed at 98° C. for 60 minutes at a pH of 7.0, and a temperature rise rate of 1.5° C. per minute. Two dyestuffs were used in each case, the direct dye Acidol Brilliant Blue M5G which gives a bright turquoise shade, and the acid dye Supranol Turquoise GGL, which has less tendency to generate stripes, but which gives a ‘flatter’ duller color. The results, as assessed subjectively by a panel of experts showed that the optically brightened fabric gave a much more brilliant color than did the control fabric when dyed with the Supranol (duller) dye in each case, and that the optically brightened Supranol fabric was superior even to the standard fabric with the more brilliant Acidol dye. These judgments were confirmed by the instrumental measurements show in Table 8 below.

TABLE 8
CIE L*a*b* Values for 96(78)f68 textured yarn fabrics

| Yarn | Dyestuff | L | a | b | C | h |
|---|---|---|---|---|---|---|
| Control | Acidol | 69.45 | −32.58 | −22.95 | 39.85 | 215.16 |
| Control | Supranol | 68.13 | −31.95 | −22.18 | 38.89 | 214.76 |
| Opt Bright | Supranol | 69.09 | −31.79 | −25.54 | 40.77 | 218.78 |

Here, the C-value, Chroma, is the most relevant parameter. These data of Table 8, show a value of 39.85 for the standard yarn with the brilliant Acidol turquoise dye. The Chroma drops to only 38.89 when the duller Supranol turquoise is used. However, the duller Supranol gives a C-value of 40.77 when used on the optically brightened yarn.

1. A polyamide composition, comprising an optical brightener agent and a component selected from the group consisting of an antimicrobial agent, an anti-oxidant stabilizer and mixtures thereof.

2. The composition according to claim 1 further comprising a modifier which renders the polyamide receptive to cationic dyes.

3. The composition according to claim 1, wherein the polyamide composition comprises polyhexamethylene diamine adipamide, polycaproamide, or copolymers thereof.

4. The composition according to claim 1, wherein the optical brightener is selected from the group consisting of: a triazine type, a coumarin type, a benzooxazole type, a stilbene type and 2,2′-(1,2-ethenediyldi-4,1 phenylene)bisbenzoxazole.

5. The composition according to claim 1, wherein the optical brightener is present in an amount of about 0.01 to about 0.2 percent by weight of the total composition.

6. The composition according to claim 1, wherein the antimicrobial agent is a silver-containing compound and the amount of silver by weight is from 2 to 800 parts per million.

7. The composition according to claim 1, wherein the antimicrobial agent is present in the composition in an amount of about 0.1 to about 0.4 percent by weight.

8. The polyamide composition according to claim 1, wherein the composition has about 25 to about 130 gram equivalents of amine ends per 1000 kilograms of polymer and a relative viscosity greater than 32.

9. A yarn comprising at least a single filament comprising the polyamide composition according to claim 1.

10. The yarn of claim 9, wherein the yarn is selected from the group consisting of a low oriented yarn, partially oriented yarn, fully drawn yarn, flat drawn yarn, draw textured yarn, air-jet textured yarn, bulked continuous filament yarn and spun staple.

11. A fabric made from the yarn of claim 9.

12. A garment made from the fabric of claim 11.

13. A carpet made from the yarn of claim 9.

14. A process for producing a heat-set polyamide fabric, comprising: constructing a fabric from an optically brightened nylon yarn, and heating the fabric to a temperature in the range of about 160° to about 220° Celsius for a period of about 20 seconds to about 90 seconds wherein the fabric has a CIE whiteness of at least 75, measured after the fabric was heat set.

15. The process of claim 14, further comprising introducing the heat set polyamide fabric into a mold; and subjecting the fabric to a pressure of at least 6 bar at a temperature that is 5 to 15° C. higher than the heat set temperature for up to 60 seconds to form a molded article.

16. The process of claim 15, wherein the molded article is a brassiere cup.

17. A process for making a molded article, wherein the article has a CIE whiteness of at least 75, comprising; introducing into a mold a previously heat-set polyamide fabric containing optically brightened nylon yarn, subjecting the previously heat-set polyamide fabric to a pressure of about 6 bar at a temperature 5 to 15° C. higher than the previous heat-setting temperature for a time period of up to 60 seconds.

18. The process of claim 17, wherein the molded article comprises a brassiere cup.

19. A polyamide composition comprising:
an optical brightener wherein the optical brightener is present in an amount of about 0.01 to about 0.2 percent by weight of the total composition;
an antimicrobial agent wherein the antimicrobial agent is a silver-containing compound and the antimicrobial agent is present in the composition in an amount of about 0.1 to about 0.4 percent by weight;
an anti-oxidant stabilizer; and
wherein said composition has about 25 to about 130 gram equivalents of amine ends per 1000 kilograms of polymer and an RV greater than 32.

20. The composition according to claim 19, wherein the amount of silver by weight is from 2 to 800 parts per million.
